(19) United States
(12) Patent Application Publication
(10) Pub. No.: US 2021/0081991 A1
(43) Pub. Date: Mar. 18, 2021

(54) Web-based Embedded Marketing Engagement and Methods Thereof

(71) Applicant: Insticator, Inc., New York, NY (US)

(72) Inventor: Zachary Dugow, New York, NY (US)

(21) Appl. No.: 16/572,800

(22) Filed: Sep. 17, 2019

(51) Int. Cl. G06Q 30/02

(52) U.S. Cl. CPC G06Q 30/0256; G06Q 30/0224; G06Q 30/0277; G06Q 30/0239; G06Q 30/0226

(57) ABSTRACT

A web-based method of displaying advertising and embedded content on a user device includes: determining an identity of a user visiting a web page, the identity of the user determined based on an identification code associated with the user; displaying an interactive interface on the web page, the interactive interface configured to receive input from the user in response to prompts displayed on the interactive interface; retrieving content to display to the user on the interactive interface, the content including questions for the one or more prompts selected based on stored data associated with the user; retrieving one or more advertisements based on an identity of the user, wherein the advertisements are selected based on stored data associated with the user; and rendering the one or more advertisements on the web page in proximity to the interactive interface.

### FIELD

This disclosure relates to computer-implemented methods and systems of providing interactive marketing engagement on a webpage. More particularly, this disclosure relates to a web-based embedded marketing engagement system and methods thereof for interactive engagement by a user visiting a webpage.

### BACKGROUND

Various forms of online marketing exist with the goal of engaging a user visiting a web page with the goal of facilitating a sale or transaction with the user. Existing types of online advertising include displaying banners or other ads that are embedded within a web page being visited by the user and displayed on a screen of a device of the user. Some existing methods provide banners or other advertisements that may be targeted to the specific user, such as based on a browsing history of the user.

While the above methods enable advertisements to be displayed to users, such methods do not actively capture engagement of the users. Increasing engagement of users can increase the value of advertisements shown to the user and increase revenue derived from advertising. Further, existing methods and processes do not capture feedback from a user engaging an advertisement or embedded content displayed on a webpage. Capturing feedback from a user, such as in the form of survey information, habits, demographics, and other information from the user can help provide useful information to determine what type of content to display to the user. Further, engagement of the user benefits both a publisher and advertiser by driving revenue based on advertisements displayed on a publisher's website and by capturing data of users visiting the publisher's website for advertisers.

What is needed, therefore, is a web-based embedded marketing engagement system and methods thereof for interactive engagement by a user visiting a webpage.

### SUMMARY

The above and other needs are met by a web-based embedded marketing engagement system and methods thereof for interactive engagement by a user visiting a webpage. In a first aspect, a web-based method of displaying advertising and embedded content on a user device includes: determining an identity of a user visiting a web page, the identity of the user determined based on an identification code associated with the user; displaying an interactive interface on the web page, the interactive interface configured to receive input from the user in response to prompts displayed on the interactive interface; retrieving content to display to the user on the interactive interface, the content including questions for the one or more prompts selected based on stored data associated with the user; retrieving one or more advertisements based on an identity of the user, wherein the advertisements are selected based on stored data associated with the user; and rendering the one or more advertisements on the web page in proximity to the interactive interface.

In one embodiment, the method further includes assigning a score to the user, wherein the score is based on a number of prompts to which the user has responded. In another embodiment, the method further includes issuing a reward to the user when the user has accumulated a designated number of points.

In yet another embodiment, web-based methods of displaying advertising and embedded content on a user device further include customizing the interactive interface based on the stored data associated with the user.

In one embodiment, web-based methods of displaying advertising and embedded content on a user device further include parsing the user responses to prompts displayed on the interactive interface and storing data corresponding to the parsed responses in association with the user. In another embodiment, methods further include customizing the interactive interface and the advertisements based on data corresponding to the parsed responses to prompts displayed on the interactive interface.

In one embodiment, web-based methods of displaying advertising and embedded content on a user device further include storing browsing history data of the user in association with an identification of the user.

In another embodiment, the prompts displayed on the interactive interface are one of trivia questions, poll questions, lifestyle profiling questions, demographic profiling questions, and market research questions.

### BRIEF DESCRIPTION OF THE DRAWINGS

Further features, aspects, and advantages of the present disclosure will become better understood by reference to the following detailed description, appended claims, and accompanying figures, wherein elements are not to scale so as to more clearly show the details, wherein like reference numbers indicate like elements throughout the several views, and wherein:

FIG. 1 shows a schematic diagram of a system for web-based embedded marketing engagement according to one embodiment of the present disclosure;

FIG. 2 shows a user device according to one embodiment of the present disclosure;

FIGS. 3A and 3B show an interactive interface including customized content according to one embodiment of the present disclosure;

FIGS. 4A and 4B show an embodiment of an interactive interface of an embedded application according to the present disclosure;

FIG. 5 shows an interactive interface including a featured story displayed to the user according to one embodiment of the present disclosure;

FIGS. 6A-6D illustrate an interactive interface including one or more advertising units displayed in proximity to the interactive interface according to one embodiment of the present disclosure; and

FIGS. 7A-7C illustrate embodiments of an interactive interface including one or more advertising units according to the present disclosure.

### DETAILED DESCRIPTION

Various terms used herein are intended to have particular meanings. Some of these terms are defined below for the purpose of clarity. The definitions given below are meant to cover all forms of the words being defined (e.g., singular, plural, present tense, past tense). If the definition of any term below diverges from the commonly understood and/or dictionary definition of such term, the definitions below control.

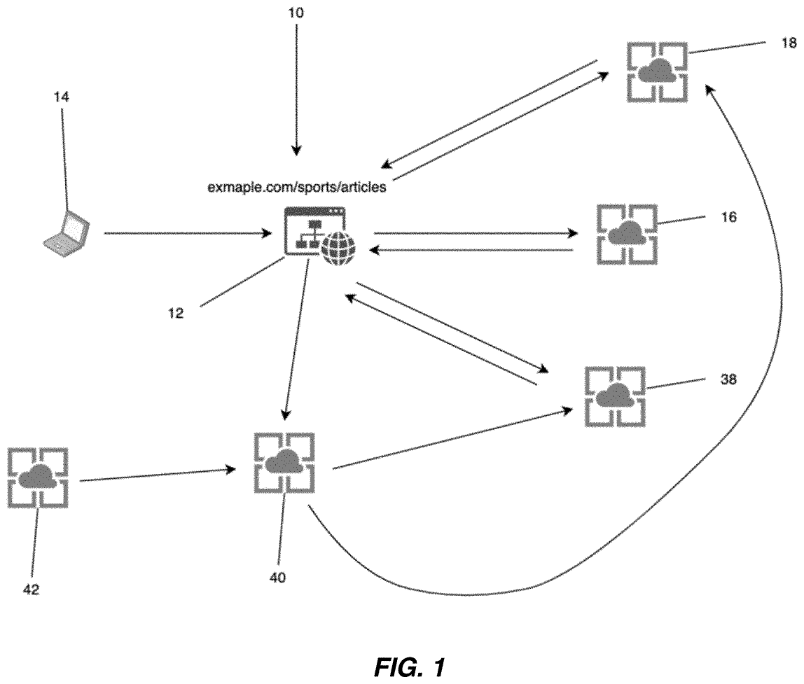

FIG. 1 shows a basic embodiment of a system for web-based embedded marketing engagement 10 according to one embodiment of the present disclosure. Embodiments herein enable a user visiting a webpage 12 on a user device 14. When the user visits the webpage 12, an embedded application 16 is displayed on the user device 14. The user may interact with the embedded application 16, such as by responded to questions or other content shown to the user through the embedded application 16. Data collected from the user interacting with the embedded application 16 can include responses by the user to trivia or poll questions displayed to the user through the embedded application 16. Particular users may be tracked using an identification of the user such that the user may accumulate points or rewards based on interaction of the user with the embedded application 16. Embodiments described herein advantageously encourage the user to interact with the embedded application 16 and advertisements associated therewith, thereby enhancing impression of advertisements on the user when the user visits the webpage 12.

Embodiments of portions of the system for web-based marketing engagement 10 are accessible by a user through the user device 14 in communication with one or more servers hosting the embedded application 16 and other components as described herein. Embodiments include computer executable code operable on the one or more servers and one or more databases on the one or more servers including data corresponding to various advertisers, publishers, user data, and other data collected according to systems and methods disclosed herein.

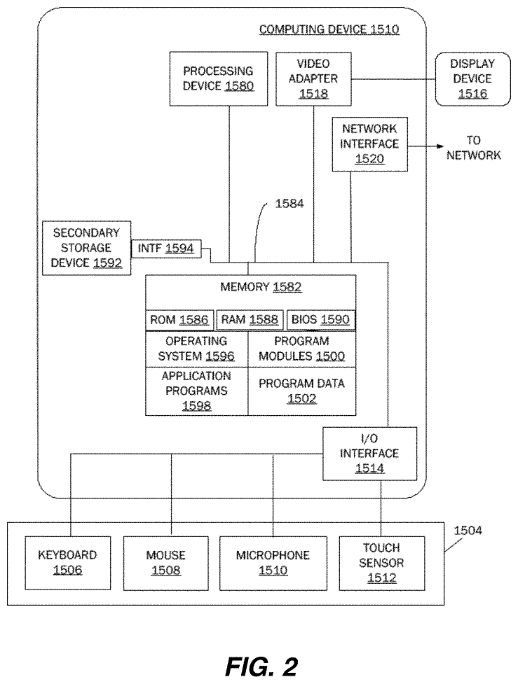

The user-facing application 106 may reside on a server, and all or portions of the user-facing application are accessible by a user through a user device in communication with the server hosting the user-facing application. Suitable user devices include a display, a processor, memory, and one or more input devices for receiving input from a user on the user device, as shown in FIG. 2. The computing device 1510 includes, in some embodiments, at least one processing device 1580, such as a central processing unit (CPU). A variety of processing devices are available from a variety of manufacturers, for example, Intel or Advanced Micro Devices. In this example, the computing device 1510 also includes a system memory 1582, and a system bus 1584 that couples various system components including the system memory 1582 to the processing device 1580. The system bus 1584 is one of any number of types of bus structures including a memory bus, or memory controller; a peripheral bus; and a local bus using any of a variety of bus architectures.

A user device may include, for example, a smart phone, tablet, or personal computer of the user. The user-facing application is displayed on the user device such that the user may interact with the user-facing application using the display and one or more input devices of the user device. A user accesses the user-facing application on the user device via a web browser or through a locally installed application installed on the user device that is in communication with the user-facing application server. A user logs in to the user-facing application using a created username and password, as described in greater detail below. To further protect the user account from being compromised, user log in information may also require two-factor authentication or other available methods of computer access control. For example, when the user device comprises a smartphone, a user log in process may require verification of an identity of the user using biometric data, such as a fingerprint of the user acquired through a fingerprint sensor of the user device.

Referring again to FIG. 1, the user accesses the web page 12 on the user device 14 on which embodiments of the web-based marketing engagement system and methods described herein are implemented. The embedded application 16 is displayed on the web page 12 such that an interface of the embedded application 16 is viewable to the user when the user visits the web page 12. The embedded application 16 may be displayed on the web page 12 by embedding code or otherwise retrieving the embedded application 16 to be displayed to the user on the web page 12. The web page 12 is preferably created by a publisher and may include content created by the publisher entity.

The embedded application 16 may be selected based on a plurality of available embedded applications 16 that may be created for various types of web pages 12. For example, one or more custom embedded applications 16 may be created having unique appearances or information displayed on the embedded application 16 particular to a publisher's web page 12. A plurality of created embedded applications 16 may be stored on a server for retrieval upon accessing the web page 12 by a user. Alternatively, a custom embedded application 16 may be generated based on an identity of an owner of the web page or a user visiting the web page.

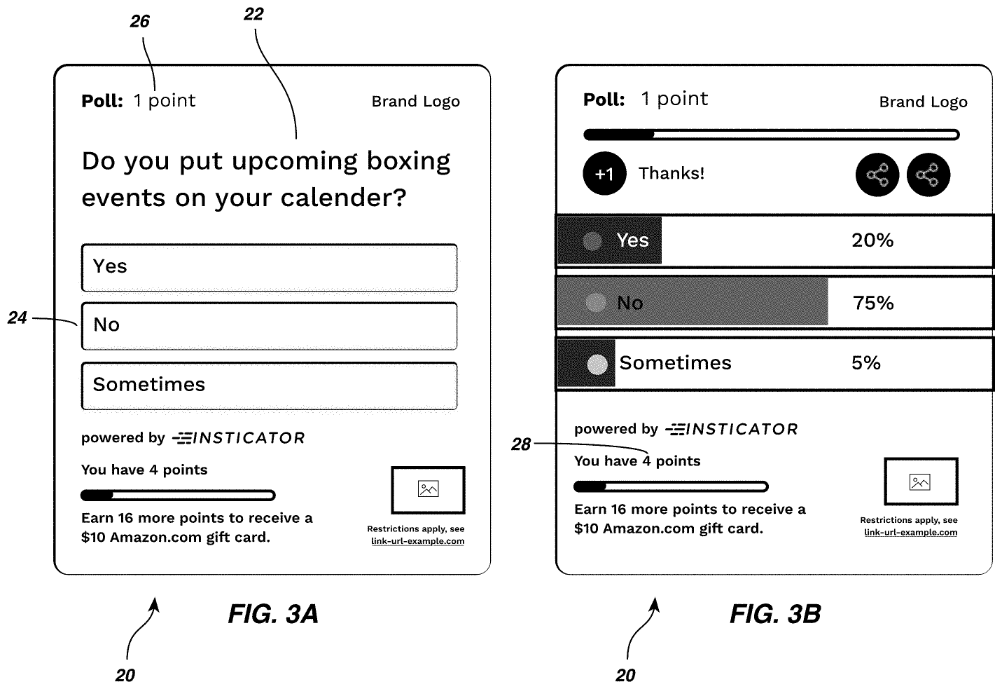

Referring now to FIGS. 3A and 3B, the embedded application 16 includes an interactive interface 20 that is rendered on the web page 12 and displayed to the user visiting the web page 12. The interactive interface 20 preferably includes a prompt 22, such as a trivia or poll questions, to be answered by the particular user viewing the web page 12. The user may select a response 24, such as an answer that the user believes is correct in response to the prompt 22. After selecting a desired response, the interactive interface 20 displays whether the user answered the prompt 22 correctly, or may display how other users have responded to the same questions as shown in FIG. 3B. The interactive interface 20 may further display a point value 26 of each question along with a total point value 28 based on the number of questions or responses provided by a particular user. Further displayed on the interactive interface 20 is a brand logo 30 visible in proximity to the prompt 22, the brand logo 30 corresponding to one or both of the publisher and advertiser associated with the embedded application 16.

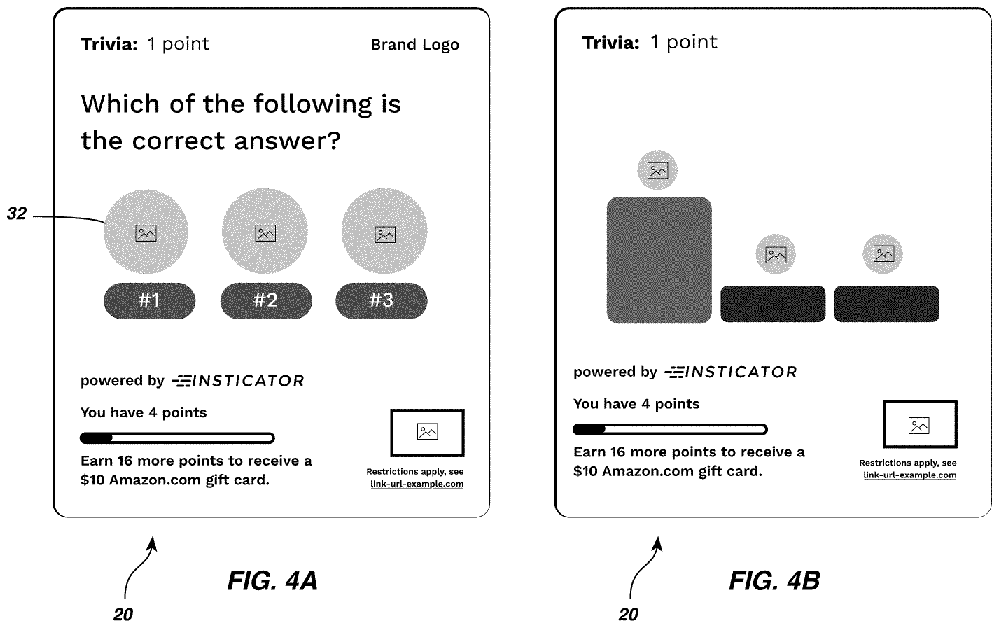

In one embodiment, the interactive interface 20 of the embedded application 16 displays one or more images 32 for the user to select in response to the prompt 22, as shown in FIGS. 4A and 4B. Each of the one or more images 32 may be displayed in proximity to a response selected by the user. After the user selects a response, such as in response to a poll question, a correct response or poll result is then displayed to the user on the interactive interface 20 as shown in FIG. 4B.

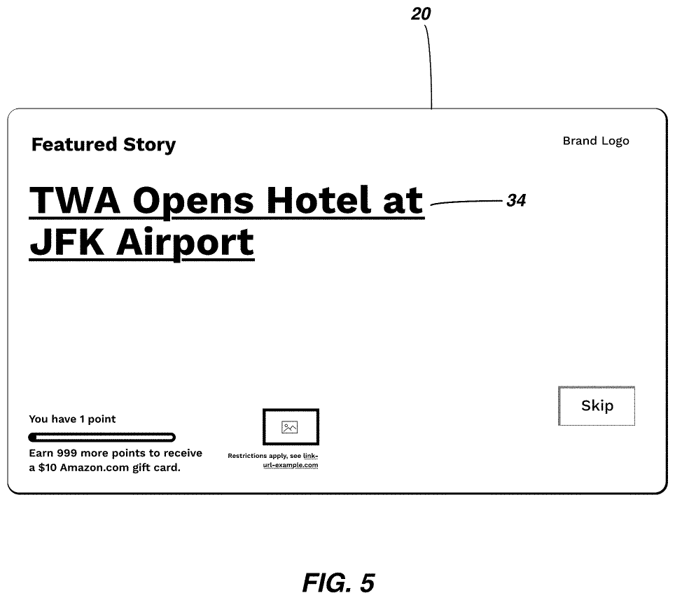

Referring to FIG. 5, in one embodiment content is displayed on the interactive interface 20 of the embedded application 16 when a user has engaged the embedded application 16. For example, a featured story 34 may be displayed on the interactive interface 20 in between trivia or poll questions displayed to the user. The featured story 34 may be a story generated by the publisher or website displaying embedded application 16 and may include a hyperlink to a web page showing the featured story 34. Alternatively, other stories or content may be displayed on the interactive interface 20 in between poll or trivia questions engaged by the user.

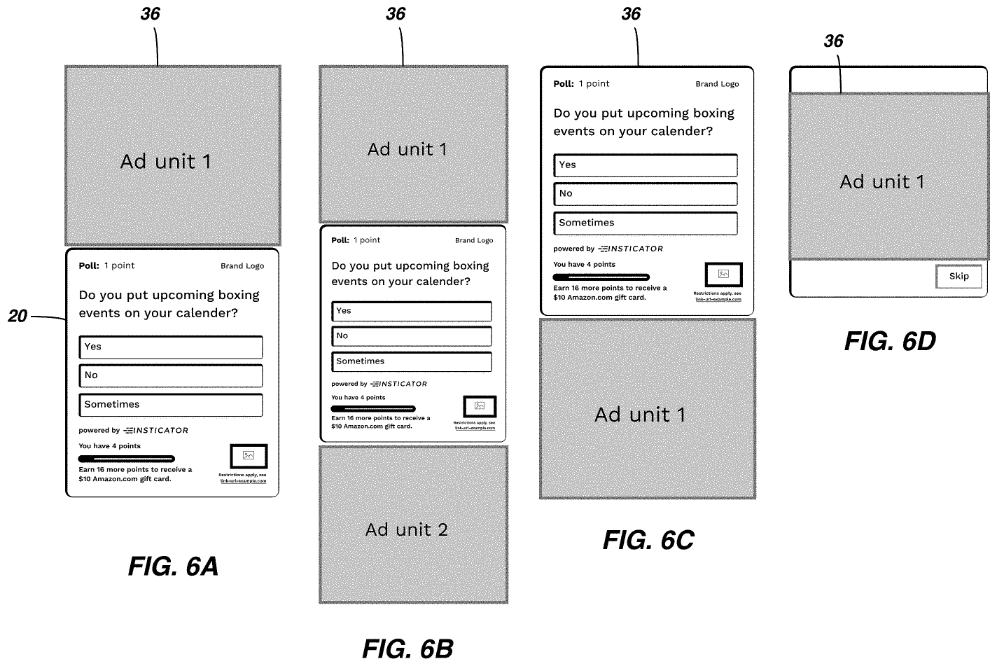

Referring now to FIGS. 6A-6D, the embedded application 16 is preferably displayed on the web page in proximity to or otherwise associated with one or more ad units 36. The one or more ad units 36 are displayed in proximity to the interactive interface 20 of the embedded application 16 as shown in FIGS. 6A-6C. For example, the one or more ad units 36 may be placed above, below, or beside the interactive interface 20 such that when a user engages the interactive interface 20 the one or more ad units 36 are impressed upon the user engaging the interactive interface 20. Alternatively, as shown in FIG. 6D, the one or more ad units 36 may be presented within the interactive interface 20 such as between trivia or poll questions displayed to the user. The one or more ad units 36 are generated based on retrieved advertising data and information of the user as discussed in greater detail below.

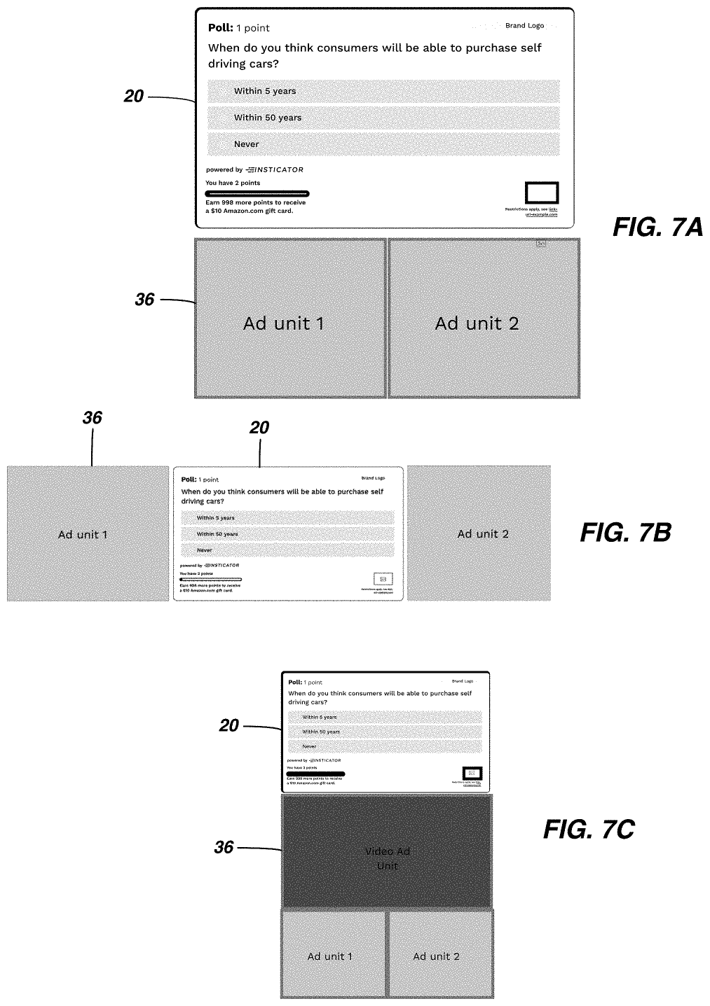

As shown in FIGS. 7A-7C, the one or more ad units 36 may further be in proximity to the interactive interface 20 when the interactive interface 20 is located within content of the web page. Further, the one or more ad units 36 may include one or more videos shown in proximity to the interactive interface 20 as shown in FIG. 7C.

Advertising data is stored on an advertising module 18 and is retrievable for display on the web page 12 in association with the embedded application 16. Advertising data preferably includes one or more digital advertisements created by or for various advertising entities. Various digital advertisements are preferably stored on the advertising database 18 or otherwise retrievable on the web page 12 that correspond to various advertising entities and products or services offered by those advertising entities. The plurality of advertisements may be retrieved and rendered on the web page 12 as described in greater detail below.

Referring again to FIG. 1, methods of web-based marketing including an embedded application shown on a web page are described. Methods include displaying the one or more ad units 36 in visual proximity to the interactive interface 20 wherein the one or more ad units 36 are retrieved based on the user interacting with the interactive interface 20. Systems described herein include various modules associated with the embedded application 16 and the web page 12 such that data corresponding to the user visiting the web page 12 may be collected and customized advertisements displayed to the user that are based on data collected on the user. Each module as described herein may include data that is retrievable from or storable on a database hosted on one or more servers. One or more processors of the servers may receive instructions corresponding to requests for data or data to be stored and may subsequently retrieve or store data based on received instructions.

Interaction of various modules described herein and methods related thereto are described in greater detail below. FIG. 1 illustrates the advertising module 18 that includes one or more digital advertisements created by or for various advertising entities. Various digital advertisements are preferably stored in a database or otherwise retrievable on the web page 12 that correspond to various advertising entities and products or services offered by those advertising entities. The plurality of advertisements may be retrieved and rendered on the web page 12 as described in greater detail below.

FIG. 1 further illustrates a content management module 38 from which content for the embedded application 16 to be displayed to the user on the web page 12. Content customized for the user viewing the embedded application 16 includes trivia questions, poll questions, lifestyle profiling questions, demographic profiling questions, and market research questions that are displayed on the interactive interface 20 of the embedded application 16 such that the user may respond to questions presented on the interactive interface 20. Responses to content customized for the user may be captured for analysis and stored in a database associated with a data management module 40. Further, additional data corresponding to content displayed on the web page 12 is stored in a database associated with the data management module 40, such as data related to content displayed on the web page 12 on which the embedded application 16 is also displayed.

Systems and methods herein further include a demand side module 42 for tracking particular users based on a unique identification number assigned to the user. Data related to the user including data related to other web pages visited by the user may be collected and stored for further analysis to determine and display content to the user through the embedded application 16.

Embodiments herein include methods of displaying content to a user on the web page 12 and for analyzing data of the user based on responses provided by the user through the embedded application 16 on the web page 12. In a first step, a user visits the web page on the user device. The web page preferably corresponds to a publisher, such as a web page featuring informational articles or other content to be consumed by the user through the user device. The web page is rendered and displayed on a display of the user device such that the user may view content of the web page on the user device.

When the user device loads the web page, code embedded in the web page initiates a process of displaying the interactive interface of the embedded application on a portion of the web page such that the interactive interface is viewable to the user and that the user may engage the interactive interface through the user device. When the user initially loads the web page, code embedded in the application determines whether the user is a new user or whether the user has previously engaged the embedded application. An identity of the user and whether the user is a new user may be determined by, for example, cookies stored on the user device. If the user is a new user, a user identifier is assigned to the user and stored such that the user may be later identified. If the user is an existing user, the user is identified such as by one or more cookies stored on the user device.

One or more advertisements from the advertising database are then retrieved for display on the web page based on an identity of the user. If the user is identified as a returning user, data previously collected on the user may be analyzed to fetch appropriate advertisements of the user that may be displayed to the user on the web page in proximity to the embedded application as described above. Advertisements may be selected using, for example, header bidding, to display advertisements of interest to the user. Advertisements are fetched and displayed to the user as the one or more ad units 36 in proximity to the interactive interface 20 of the embedded application 16, as described above.

Further, when the identity of the user is determined, the interactive interface 20 may be customized for the user based on data collected on the user. For example, the types of prompts displayed to the user on the user device may be customized based on data on the user, such as data relating to topics of interest for the user. Additional data corresponding to the user may be retrieved and displayed on the interactive interface of the embedded application such as a total number of points accumulated by the user and displayed to the user on the embedded application.

When the web page is loaded, the retrieved advertisements specific to the identified user are displayed on the web page in proximity to the interactive interface of the embedded application that is also displayed on the user device on the web page. The retrieved advertisements are preferably displayed in proximity to the interactive interface of the embedded application such as on sides or above and below the embedded application displayed on the web page on the user device. The retrieved advertisements are rendered based on advertisement data retrieved from the advertisement database and visually presented to the user in proximity to the embedded application.

In addition to fetching advertisements for the user, content to be displayed on the embedded application is retrieved that is also based on the user including historical activities of the user and other data collected on the user and stored in a database and associated with the particular user. Customized content for the user that is displayed on the embedded application on the web page may include, for example, one or more of customized trivia questions, poll questions, lifestyle profiling questions, demographic profiling questions, and market research questions.

Customized content is displayed on the web page on the interactive interface such that the user may select various responses to the customized content. Responses entered by the user on the interactive interface are stored in association with other data of the user for further analysis. Stored responses to the customized content displayed on the interactive interface may be parsed to determine a meaning of the content and stored in association with data of the user, such as in a database of the data management module. In addition to responses entered by the user, additional data corresponding to the user's session on the web page is collected and stored with the user's responses to the customized content. For example, data of the web page including content of the publisher of the web page including text within the content or a general category of content being shown to the user. Content of the web page may be analyzed, for example, using natural language processing (“NLP”) algorithms to analyze textual content of the web page and associated analyzed data with the user. Data collected from content of the web page may be stored in association with data of the user such that when future customized content is generated for display to the user the customized content may be selected based on past content viewed by the user.

Additional data may be collected and stored in association with data of the user in a database of the demand side module. In one embodiment, when a user is assigned an ID such as through one or more cookies stored on the user device, additional activity of the user may be tracked and collected including other web pages viewed by the user including web sites that do not include the embedded application. Additional data collected on the user may be further analyzed, such as by using NLP algorithms, to further identify relevant interests of the user and content of interest for the user.

The user may accumulate points that are associated with the user and stored such that whenever the user views the embedded application on a web page, the user is shown a total number of points associated with the user. For example, the user may be awarded a point value for responding to a prompt on the interactive application of the embedded application on the web page. When the user accumulates a designated number of points, the user may be rewarded such as with a gift card or other reward for engaging the interactive interface of the embedded application. A point total of the user may be tracked across multiple web pages visited by the user that include the embedded application such that the user may accumulate points for engaging the embedded application on a plurality of web pages viewed by the user.

Embodiments described herein advantageously enhance engagement of the user with content of the web page such that the user is more likely to be presented with relevant content that is of interest to the user. Further, advertisements shown in close proximity to the interactive interface are fetched that are relevant to interests of the user, thereby further increasing the likelihood that the user will engage advertisements displayed to the user in proximity to the interactive application, thereby yielding higher completion rates and higher CPM for advertisements displayed to the user and higher revenue for publishers displaying the embedded application on the web page.

The foregoing description of preferred embodiments of the present disclosure has been presented for purposes of illustration and description. The described preferred embodiments are not intended to be exhaustive or to limit the scope of the disclosure to the precise form(s) disclosed. Obvious modifications or variations are possible in light of the above teachings. The embodiments are chosen and described in an effort to provide the best illustrations of the principles of the disclosure and its practical application, and to thereby enable one of ordinary skill in the art to utilize the concepts revealed in the disclosure in various embodiments and with various modifications as are suited to the particular use contemplated. All such modifications and variations are within the scope of the disclosure as determined by the appended claims when interpreted in accordance with the breadth to which they are fairly, legally, and equitably entitled.

What is claimed is:

1. A web-based method of displaying advertising and embedded content on a user device, the method comprising:
determining an identity of a user visiting a web page, the identity of the user determined based on an identification code associated with the user;
displaying an interactive interface on the web page, the interactive interface configured to receive input from the user in response to prompts displayed on the interactive interface;
retrieving content to display to the user on the interactive interface, the content including questions for the one or more prompts selected based on stored data associated with the user;
retrieving one or more advertisements based on an identity of the user, wherein the advertisements are selected based on stored data associated with the user; and
rendering the one or more advertisements on the web page in proximity to the interactive interface.

2. The web-based method of displaying advertising and embedded content on a user device of claim 1, the method further comprising assigning a score to the user, wherein the score is based on a number of prompts to which the user has responded.

3. The web-based method of displaying advertising and embedded content on a user device of claim 2, further comprising issuing a reward to the user when the user has accumulated a designated number of points.

4. The web-based method of displaying advertising and embedded content on a user device of claim 1, further comprising customizing the interactive interface based on the stored data associated with the user.

5. The web-based method of displaying advertising and embedded content on a user device of claim 1, further comprising parsing the user responses to prompts displayed on the interactive interface and storing data corresponding to the parsed responses in association with the user.

6. The web-based method of displaying advertising and embedded content on a user device of claim 5, further comprising customizing the interactive interface and the advertisements based on data corresponding to the parsed responses to prompts displayed on the interactive interface.

7. The web-based method of displaying advertising and embedded content on a user device of claim 1, further comprising storing browsing history data of the user in association with an identification of the user.

8. The web-based method of displaying advertising and embedded content on a user device of claim 7, wherein the prompts displayed on the interactive interface are one of trivia questions, poll questions, lifestyle profiling questions, demographic profiling questions, and market research questions.
